(19) United States
(12) Patent Application Publication
(10) Pub. No.: US 2012/0253979 A1
(43) Pub. Date: Oct. 4, 2012

(54) SYSTEM AND METHOD FOR APPLYING CREDIT CARD

(76) Inventor: Young-Ki Kim, Seoul (KR)

(21) Appl. No.: 13/525,837

(22) Filed: Jun. 18, 2012

Related U.S. Application Data
(63) Continuation of application No. PCT/KE2010/008962, filed on Dec. 15, 2010.

(30) Foreign Application Priority Data
Dec. 24, 2009 (KR) 10-2009-0130551

(51) Int. Cl. G06Q 30/06

(52) U.S. Cl. 705/26.41

(57) ABSTRACT

The present invention relates to a method of using a credit card to make international trade payments, and to a system whereby a central the buyer bank may make international trade payments by applying the credit card system. The present international trade payment system allows for debit and credit between the buyers and the suppliers with only an importer country server, and no exporter country server is needed for the buyers and the suppliers to pay for transactions.

### CROSS-REFERENCE TO RELATED APPLICATIONS

The following application is a continuation of International Patent Application No. PCT/KR2010/008962, filed on Dec. 15, 2010, which claims the benefit of Korean Patent Application No. 10-2009-0130551, filed on Dec. 24, 2009, the entire disclosures of which are both incorporated herein by reference for all purposes.

### BACKGROUND

1. Field

The present invention relates to an international trade payment system and method and, more particularly, to an international trade payment system and method based on a buyer bank using a credit card system which perform international trade payment over a network, such as the Internet, using a credit card.

2. Background

As the spread of the Internet is recently suddenly increased, electronic commerce is performed for people all over the word through the same medium called the Internet.

In general, electronic commerce includes not only commercial transactions accompanied by the flow of money using electronic media and electronic technology and means, but also a series of behaviors, such as purchaser marketing, advertisement, supply, service, production, transport, and purchase under an automated information system environment integrated into Business to Business (BtoB), Business to Customer (BtoC), Customer to Customer (CtoC), or Business to Government (BtoG).

This electronic commerce is spread into various fields, such as finance, education, and exhibition, and is widely used in all commercial transaction behaviors performed over a network and in the form supporting all the commercial transaction behaviors.

Transactions between business to consumers were chiefly performed, but there is a tendency that transactions between business and business are chiefly performed.

According to this tendency, international business is recently spread, and thus electronic trade has appeared.

Electronic trade means that part or all of trade is performed using an information communication network having an information processing ability, such as a computer. With the advent of electronic trade, a variety of electronic payment means for overcoming disadvantages, such as a letter of credit and collection which are conventional dynamic payment methods, and supporting smooth trade payment are emerging in a payment method.

Today, an official electronic payment system includes Trade Card, Bill Of Lading Electronic Registry Organization (BOLERO), and Identrus.

If trade transactions are settled using this electronic payment means, however, there are disadvantages in that a buyer and a supplier must always access a system for managing and settling electronic payment means over a network and a lot of time is taken for participants to be electronically connected.

In addition to trade payment using the electronic payment means, if a traditional letter of credit is used, there were disadvantages in that lots of incidental expenses are consumed in mass transactions and a transaction is not performed rapidly.

### SUMMARY

The present invention has been made to solve the above problems, and an object of the present invention is to provide an international trade payment system and method based on a buyer bank using a credit card system, which enables payment between a buyer and a supplier even without placing an additional server in an exporting country in an international trade payment system.

An aspect according to an international trade payment system based on a buyer bank using a credit card system of the present invention may include a database; a card member management unit/member store management unit for storing and registering card member information about a buyer, including information about terms and conditions of business and the payment account of a buyer, and information about the member store of a supplier, including information about the pre-designated account of the supplier, in and with the database; an approval processing unit for searching for credit information about the buyer registered with the database when information about a transaction contract agreement with the supplier and payment information including a payment day set by the buyer is received from a buyer terminal, giving approval according to the transaction limit range and the terms and conditions of business of the buyer, and informing a supplier terminal of an approval history of the buyer; and a card payment processing unit for informing that the buyer deposits a price on the payment day, performing processing so that the transaction amount is deposited in the pre-designated account of the supplier, designated when member store information was registered, on the payment day, and completing transaction amount redemption processing of the buyer when the buyer deposits the transaction amount on the payment day.

An aspect according to an international trade payment method based on a buyer bank using a credit card system of the present invention may include the steps of a buyer bank server receiving card member information about a buyer, including information about terms and conditions of business and a payment account of the buyer, and information about the member store of a supplier, including information about the pre-designated account of the supplier, from a buyer terminal and registering the card member information and the information about the member store with a database; the buyer bank receiving information about a transaction contract agreement with the supplier and payment information, including a payment day set by the buyer, from the buyer; the buyer bank searching the database for registration credit information about the buyer when the information about the transaction contract agreement is received (an approval request) and processing approval according to a transaction limit range and the terms and conditions of business of the buyer; the buyer bank informing a supplier terminal of an approval history of the buyer by sending the approval history to the supplier terminal; the buyer bank informing the buyer that a price is deposited on the payment day and performing processing so that the transaction amount is deposited in the pre-designated account of the supplier, designated when member store information was registered, on the payment day; and the buyer bank completing transaction amount redemption processing of the buyer when the buyer deposits the transaction amount on the payment day.

Furthermore, another aspect according to an international trade payment method based on a buyer bank using a credit card system of the present invention may include the steps of a buyer bank server receiving card member information about a buyer, including information about terms and conditions of business and the payment account of the buyer, and information about the member store of a supplier, including information about the pre-designated account of the supplier, from a buyer terminal and registering the card member information and the information about the member store with a database; the buyer bank server receiving information about a transaction contract agreement and payment information, including a payment day set by the buyer, from an eMP through the eMP after the buyer and the supplier made the contract; the buyer bank server searching the database for registration credit information about the buyer when the information about the transaction contract agreement is received (an approval request) and processing approval according to a transaction limit range and the terms and conditions of business of the buyer; the buyer bank server informing a supplier terminal of an approval history of the buyer by sending the approval history to the supplier terminal; the buyer bank server informing the buyer terminal that a price is deposited on the payment day and performing processing so that the transaction amount is deposited in the pre-designated account of the supplier, designated when member store information was registered, on the payment day; and the buyer bank server completing transaction amount redemption processing of the buyer when the buyer terminal deposits the transaction amount on the payment day.

Furthermore, yet another aspect according to an international trade payment method based on a buyer bank using a credit card system of the present invention may include the steps of a buyer bank server receiving the credit letter of guarantee of a buyer, issued by a certification institution, from the buyer or the certification institution; the buyer bank server receiving card member information about the buyer, including information about terms and conditions of business and the payment account of the buyer, and information about the member store of a supplier, including information about the pre-designated account of the supplier, from a buyer terminal and registering the card member information and the information about the member store with a database; the buyer bank server receiving information about a transaction contract agreement and payment information, including a payment day set by the buyer, from an eMP through the eMP after the buyer and the supplier made the contract; the buyer bank server searching the database for credit information about the buyer, issued by the certification institution, when information about the transaction contract agreement is received (an approval request) and processing approval according to a transaction limit range and terms and conditions of business of the buyer; the buyer bank server informing a supplier terminal of an approval history of the buyer by sending the approval history to the supplier terminal; the buyer bank server informing the buyer terminal that a price is deposited on the payment day and performing processing so that the transaction amount is deposited in the pre-designated account of the supplier, designated when member store information was registered, on the payment day; and the buyer bank server completing transaction amount redemption processing of the buyer when the buyer terminal deposits the transaction amount on the payment day.

### BRIEF DESCRIPTION OF THE DRAWINGS

FIG. 1 is a functional block diagram showing an international trade payment system based on a buyer bank using a credit card system according to the present invention.

FIG. 2 is a flowchart illustrating an international trade payment method based on a buyer bank using a credit card system according to the present invention.

FIG. 3 is a flowchart illustrating a buyer confirmation method in the international trade payment method based on a buyer bank using a credit card system according to FIG. 2.

FIG. 4 is a flowchart illustrating a advanced payment processing method the international trade payment method based on a buyer bank using a credit card system according to FIG. 2.

FIG. 5 is a flowchart illustrating an approval cancellation method in the international trade payment method based on a buyer bank using a credit card system according to FIG. 2.

FIG. 6 is a flowchart illustrating a method using an eMP in an international trade payment method based on a buyer bank using a credit card system according to a second embodiment of the present invention.

FIG. 7 is a flowchart illustrating a method using an eMP and a certification institution in an international trade payment method based on a buyer bank using a credit card system according to a third embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

In various aspects, the international trade payment system and method based on a buyer bank using a credit card system according to the present invention has an excellent advantage in that it can provide a more convenient international trade system by enabling transaction amount payment between a buyer and a supplier by using a server in an importing country.

Furthermore, a letter of credit guaranteed in the existing trade payment is conditional guarantee (a buyer bank has a duty for payment if a negotiation is flawless). In contrast, in the present invention, after common approval, a buyer bank has an unconditional payment duty for a supplier after buyer confirmation in case of buyer confirmation conditional approval. The present invention has another excellent advantage in that it can support safe payment in international trade payment.

<Description of reference numerals of principal
elements in the drawings>

| | |
|---|---|
| 100: buyer | 200: supplier |
| 300: buyer bank server | |
| 310: at least one database | 321: card member |
| | management unit |
| 322: member store management unit | 330: approval |
| | processing unit |
| 340: card payment processing unit | 350: buyer |
| | confirmation processing unit |
| 360: advanced payment processing unit | 370: eMP |
| | management unit |
| 380: letter-of-guarantee management unit | 400: |
| | supplier bank |
| 500: eMP | 600: certification institution |

An international trade payment system based on a buyer bank using a credit card system of the present invention includes a database for storing card member information about a buyer, including information about terms and conditions of business and a payment account, information about the member store of a supplier, credit information about the buyer, including a transaction limit range and terms and conditions of business of the buyer, and information about the pre-designated account of the supplier; a card member management unit/member store management unit for storing and registering the card member information about the buyer, including the information about the terms and conditions of business and the payment account of the buyer, and the information about the member store of the supplier, including the information about the pre-designated account of the supplier, in and with the database; an approval processing unit for searching for credit information about the buyer registered with the database when information about a transaction contract agreement with the supplier and payment information including a payment day set by the buyer is received from a buyer terminal, giving approval according to the transaction limit range and the terms and conditions of business of the buyer, and informing a supplier terminal of an approval history of the buyer; and a card payment processing unit for informing that the buyer deposits a price on the payment day, performing processing so that the transaction amount is deposited in the pre-designated account of the supplier, designated when member store information was registered, on the payment day, and completing transaction amount redemption processing of the buyer when the buyer deposits the transaction amount on the payment day.

Furthermore, an aspect according to an international trade payment method based on a buyer bank using a credit card system of the present invention may include the steps of a buyer bank server receiving card member information about a buyer, including information about terms and conditions of business and a payment account of the buyer, and information about the member store of a supplier, including information about the pre-designated account of the supplier, from a buyer terminal and registering the card member information and the information about the member store with a database; the buyer bank receiving information about a transaction contract agreement with the supplier and payment information, including a payment day set by the buyer, from the buyer; the buyer bank searching the database for registration credit information about the buyer when the information about the transaction contract agreement is received (an approval request) and processing approval according to a transaction limit range and the terms and conditions of business of the buyer; the buyer bank informing a supplier terminal of an approval history of the buyer by sending the approval history to the supplier terminal; the buyer bank informing the buyer that a price is deposited on the payment day and performing processing so that the transaction amount is deposited in the pre-designated account of the supplier, designated when member store information was registered, on the payment day; and the buyer bank completing transaction amount redemption processing of the buyer when the buyer deposits the transaction amount on the payment day.

Detailed descriptions of specific embodiments provide several descriptions of the specific embodiments of the present invention. However, the present invention may be implemented using several methods which are limited and covered by the claims. The detailed descriptions are given with reference to the drawings having the same reference numerals and indicating functionally similar elements.

Terms used in the detailed description provided in this specification are merely used for a detailed description of a specific embodiment of the present invention and thus should not be construed as limiting or restricting the present invention to a specific method. Furthermore, the embodiments of the present invention may include several novel characteristics which are generally essential to indicate the preferred attributes of the present invention or to implement the invention provided in the specification.

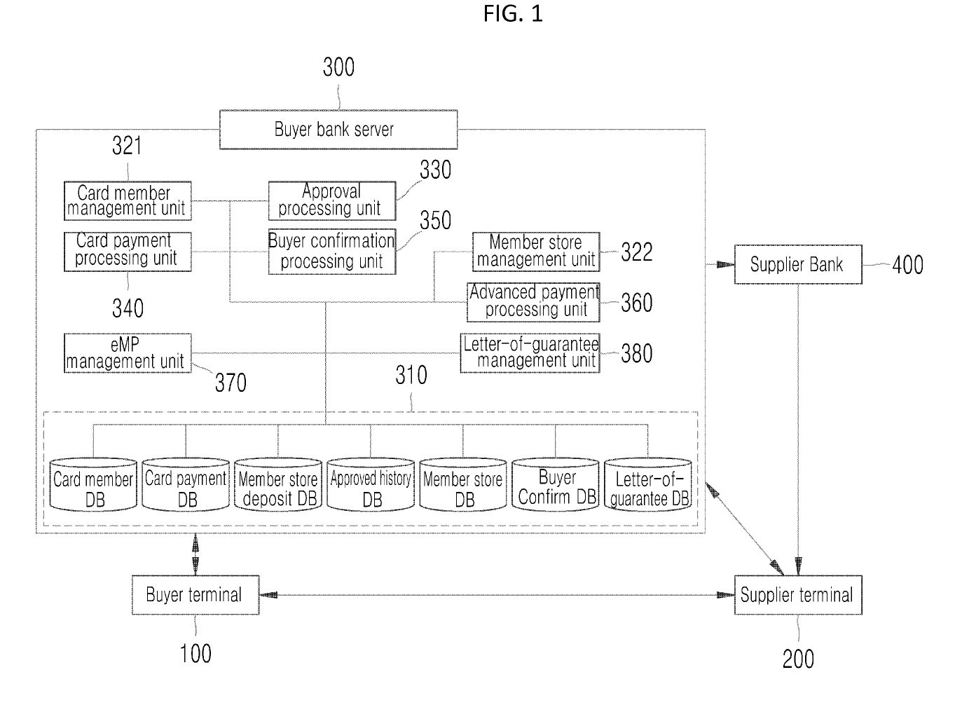

FIG. 1 is a functional block diagram showing an international trade payment system based on a buyer bank using a credit card system according to the present invention.

The international trade payment system based on a buyer bank using a credit card system according to an embodiment of the present invention includes a buyer terminal 100, a supplier terminal 200, and a buyer bank server 300. The buyer bank server 300 includes at least one database 310, a card member management unit 321, a member store management unit 322, an approval processing unit 330, and a card payment processing unit 340 and may further include a buyer confirmation processing unit 350, an advanced payment processing unit 360, an eMP (Marketplace) management unit 370, and a letter-of-guarantee management unit 380.

The buyer terminal 100 and the supplier terminal 200 are clients, that is, transaction entities (a purchaser and a seller) who try to have international trade and financial transaction and may be, for example, servers operated in companies. In addition, the buyer terminal 100 and the supplier terminal 200 may be computers using a web browser, such as Internet Explorer by Microsoft, mobile communication terminals, PDAs, or communication devices, such as TV having an Internet access function.

The buyer bank server 300 is an apparatus for performing payment processing according to trade transactions of a buyer. In particular, the buyer bank server 300 may be a server in a local bank or a card company which performs payment processing using a credit card.

The database 310 of the buyer bank server 300 is at least one, and it stores a transaction history between a buyer and a supplier, credit information about a buyer, and member store information.

Here, the database 310 of the buyer bank server 300 may include a transaction database for storing transaction history information (a transaction day, a transaction article, a transaction amount, a designated payment day, and a commission-funding party) between a buyer and a supplier, a member database for storing credit information about a buyer (a credit card number, a password, a buyer name, a business operator address, a business number, a contact point, delinquency and a delinquency rate according to a transaction history, and a credit evaluation grade according to the delinquency and delinquency rate, and a credit card limit), and a member store database for storing member store information about a supplier (supplier who have joined a member store capable performing transactions using a credit card, a member store number, a supplier name, an address of a place of business, a business number, a contact point, and a payment account). Furthermore, the database 310 may separately manage card payment information, an approval history, member store deposit information, buyer confirmation information, and information about a letter of guarantee.

Furthermore, the card member management unit 321 and the member store management unit 322 of the buyer bank server 300 receive card member information about a buyer, including terms and conditions of business and information about the payment account of the buyer, and information about the member store of a supplier, including information about the pre-designated account of the supplier, and store and register the card member information about a buyer and information about the member store of a supplier in and with the database 310.

Furthermore, when information about a transaction contract agreement with a supplier and payment information including a payment day set by a buyer are received from the buyer terminal 100, the approval processing unit 330 of the buyer bank server 300 searches for credit information about the buyer registered with the database 310, gives approval according to the transaction limit range and terms and conditions of business of the buyer, and informs the supplier terminal 200 of the approval history of the buyer by sending the approval history to the supplier terminal 200. That is, the information about the transaction contract agreement and the payment information provided by the buyer terminal 100 include information about the designation of a payment day and commission-funding designation. Here, when a transaction between a buyer and a supplier is approved, the buyer bank server 300 guarantees the money for the supplier.

Furthermore, the card payment processing unit 340 of the buyer bank server 300 informs that the buyer terminal 100 must deposit the money on the payment day, performs processing so that the transaction amount is deposited to the pre-designated account of the supplier, designated when member store information was registered, on the payment day, and completes the transaction amount redemption processing by the buyer when the buyer deposits the transaction amount on the payment day. That is, the card payment processing unit 340 performs processing so that the payment of a transaction agreed through a credit card is performed. In particular, the card payment processing unit 340 performs payment on a payment day determined by a buyer, not a payment day determined by the buyer bank server 300. A commission-funding party determined when a transaction is agreed between a buyer and a supplier pays a commission generated according to a payment day freely designated as described above.

Here, the card payment processing unit 340 may deposit the transaction amount to the supplier bank 400 using an international settlement system.

Here, if the approval is given on condition that buyer confirmation is essential in the terms and conditions of business approved between the buyer and the supplier, the buyer confirmation processing unit 350 of the buyer bank server 300 receives a buyer confirmation request history from the buyer terminal 100, process the buyer confirmation, and informs the buyer terminal 100 of the result of the buyer confirmation processing by sending the result of the buyer confirmation processing to the buyer terminal 100.

In contrast, the buyer bank server 300 informs the buyer terminal 100 of the result of the buyer confirmation processing by sending the result of the buyer confirmation processing to the buyer terminal 100 and guarantees the transaction amount for the supplier.

Meanwhile, if the supplier requests advanced payment prior to the payment day of the transaction amount, the advanced payment processing unit 360 of the buyer bank server 300 checks the approval history and the buyer confirmation history, subtracts a commission from the transaction amount according to a commission rate calculated based on the credit rating of the buyer, and deposits the remaining amount in the pre-designated account of the supplier, designated when member store information was registered, prior to the payment day of the transaction amount.

The eMP management unit 370 of the buyer bank server 300 receives payment information, including information about a transaction contract agreement and a payment day set by a buyer, from an eMP 500 through the eMP 500 after a contract is agreed between a buyer and a supplier.

Furthermore, the letter-of-guarantee management unit 380 of the buyer bank server 300 receives the credit letter of guarantee for the buyer, issued to the buyer bank server 300 by the certification institution 600, from the buyer terminal 100 or the certification institution 600, receives the card member information about the buyer, including the information about the terms and conditions of business and payment account of the buyer, and the information about the member store of the supplier, including the information about the pre-designated account of the supplier, and registers the card member information about the buyer and the information about the member store of the supplier with the database 310.

An operating process of the international trade payment system based on a buyer bank using a credit card system according to the present invention is described below.

First, the card member management unit 321 and the member store management unit 322 receive card member information about a buyer, including information about the terms and conditions of business and payment account of the buyer, and information about the member store of a supplier, including information about the pre-designated account of the supplier, from the buyer terminal 100 and registers them with the database 310.

Here, the buyer terminal 100 may access the buyer bank server 300 over a network, such as the Internet or a telephone, and then apply the registration of a card member or may write registration details by letter and then apply the registration of a card member using a mail, fax, or by someone. For example, if the registration of a member is applied through the Internet, the buyer terminal 100 drives a program (for example, a web browser) for accessing a network and inputs a URL for access to the buyer bank server 300. Next, the buyer bank server 300 provides the buyer terminal 100 with a page for member registration, and the buyer terminal 100 may perform registration by writing relevant details on the received registration page.

Meanwhile, the supplier terminal 200 may also access the buyer bank server 300 ad apply the registration of a member store capable of performing payment using a credit card. The registration of a member store of a supplier may also be performed through the Internet or a signature like the registration of a card member of a buyer.

After a contract is agreed between a buyer and a supplier as described above, when payment information, including information about a transaction contract agreement with the supplier and a payment day set by the buyer, is received from the buyer terminal 100, the approval processing unit 330 searches for credit information about the buyer registered with the database 310, gives approval according to the transaction limit range and terms and conditions of business of the buyer, and informs the supplier terminal 200 of the approval history of the buyer by sending the approval history to the supplier terminal 200.

Next, the card payment processing unit 340 informs that the buyer terminal 100 must deposit the price on the payment day and performs processing so that the transaction amount is deposited to the pre-designated account of the supplier, designated when member store information was registered, on the payment day. When the buyer terminal 100 deposits the amount payment on the payment day, the transaction amount redemption processing of the buyer is completed. That is, the card payment processing unit 340 performs processing so that the payment of a transaction agreed through a credit card is performed. In particular, the card payment processing unit 340 performs payment on a payment day, designated by a buyer, not a payment day determined by the buyer bank server 300. A commission-funding party determined when a transaction is agreed between a buyer and a supplier pays a commission generated according to a payment day freely designated as described above.

If approval is given on condition that buyer confirmation is essential in the terms and conditions of business approved between a buyer and a supplier, the buyer confirmation processing unit 350 receives a buyer confirmation request history from the buyer terminal 100, process the buyer confirmation, and informs the buyer terminal 100 of the result of the buyer confirmation processing by sending the result of the buyer confirmation processing to the buyer terminal 100.

Meanwhile, if the supplier requests advanced payment prior to the payment day of the transaction amount, the advanced payment processing unit 360 checks an approval history and the buyer confirmation history, subtracts a commission from the transaction amount according to a commission rate calculated based on the credit rating of the buyer, and deposits the remaining amount in the pre-designated account of the supplier, designated when member store information was registered, through the supplier terminal 200 prior to the payment day of the transaction amount.

The eMP management unit 370 receives payment information, including information about the transaction contract agreement and the payment day set by the buyer, from the eMP through the eMP after a contract is agreed between a buyer and a supplier.

Furthermore, the letter-of-guarantee management unit 380 receives the credit letter of guarantee for the buyer, issued to the buyer bank server 300 by the certification institution 600, from the buyer terminal 100 or the certification institution 600, receives card member information about the buyer, including information about the terms and conditions of business and payment account of the buyer, and information about the member store of the supplier, including information about the pre-designated account of the supplier, and registers the card member information about the buyer and the information about the member store of the supplier.

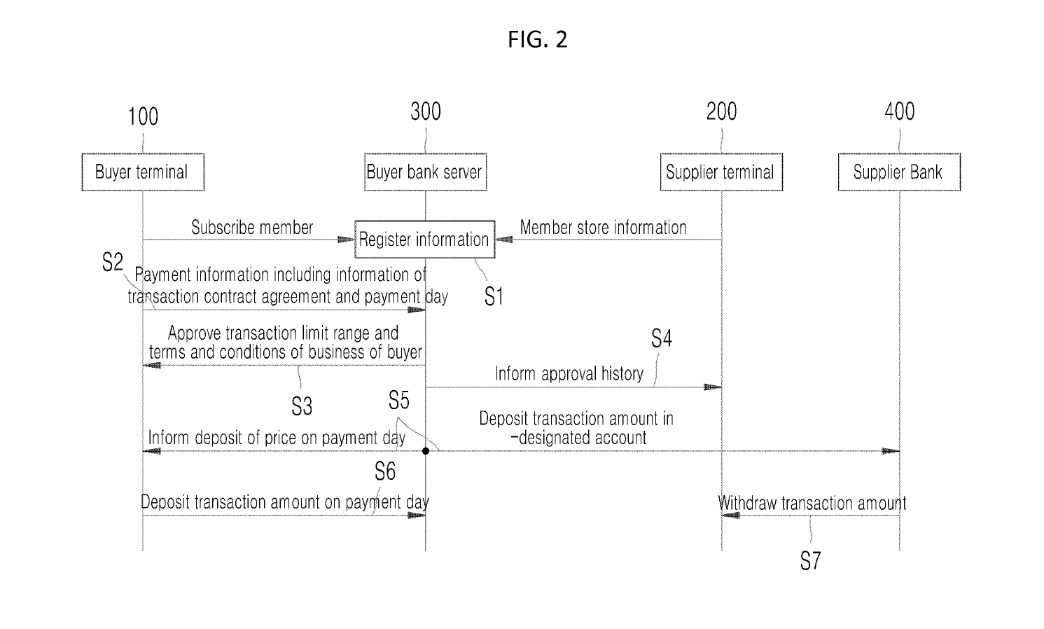

An international trade payment method based on a buyer bank using a credit card system according to the present invention is described below with reference to FIG. 2.

First, the buyer bank server 300 stores and registers card member information about a buyer, including information about terms and conditions of business and payment account of the buyer, and information about the member store of a supplier, including information about the pre-designated account of the supplier, in and with the database 310 (S1).

Next, the buyer bank server 300 receives information about a transaction contract agreement with the supplier and payment information, including a payment day set by the buyer, from the buyer terminal 100 (S2).

When the information about the transaction contract agreement is received (an approval request), the buyer bank server 300 searches the database for registered credit information about the buyer and gives approval according to the transaction limit range and terms and conditions of business of the buyer (S3). Here, when the transaction between the buyer and the supplier is approved, the buyer bank server 300 guarantees a price for the supplier.

Next, the buyer bank server 300 informs the supplier terminal 200 of the approval history of the buyer by sending the approval history to the supplier terminal 200 (S4).

Next, the buyer bank server 300 informs the buyer terminal 100 that the buyer terminal 100 must deposit the transaction amount on the payment day and performs processing so that the transaction amount is deposited in the pre-designated account of the supplier, designated when member store information was registered, on the payment day (S5).

Furthermore, when the buyer terminal 100 deposits the transaction amount on the payment day, the buyer bank server 300 completes the transaction amount redemption processing of the buyer (S6).

Meanwhile, the supplier terminal 200 withdraws the transaction amount from the pre-designated account, designated when member store information was registered, from the supplier bank 400 on the payment day and settles an expiration amount (S7).

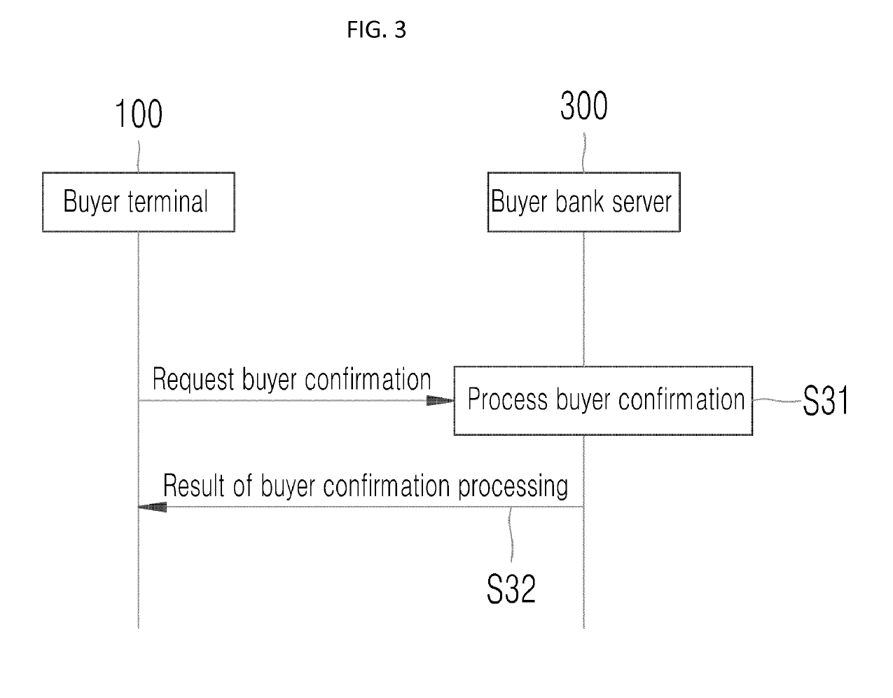

In contrast, in the step (S3) of searches for registered credit information about the buyer when the information about the transaction contract agreement is received (an approval request) and approving the transaction limit range and terms and conditions of business of the buyer, an example in which the buyer bank server 300 gives approval on condition that buyer confirmation is essential in the terms and conditions of business approved between the buyer and the supplier is described with reference to FIG. 3.

First, the buyer bank server 300 receives a buyer confirmation request history from the buyer terminal 100 and processes buyer confirmation (S31).

Next, the buyer bank server 300 informs the buyer terminal 100 of the result of the buyer confirmation processing by sending the result of the buyer confirmation processing to the buyer terminal 100 (S32).

Furthermore, after informing the buyer terminal 100 of the result of the buyer confirmation processing, the buyer bank server 300 guarantees a price for the supplier.

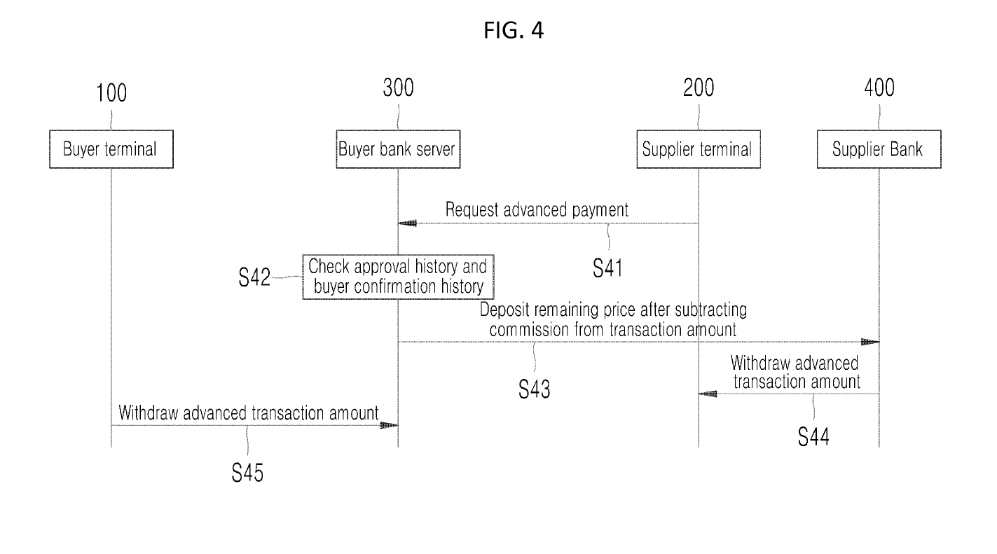

A processing method according to the request of advanced payment is described below with reference to FIG. 4.

If the supplier requests advanced payment prior to the payment day of the transaction amount (S41), the buyer bank server 300 checks an approval history and a buyer confirmation history (S42), subtracts a commission from the transaction amount according a commission rate calculated based on the credit rating of the buyer, and deposits the remaining amount in the pre-designated account, designated when member store information was registered, prior to the payment day of the transaction amount (S43).

Meanwhile, the supplier withdraws the advanced payment transaction amount from the pre-designated account of the supplier bank 400, designated when member store information was registered, prior to the payment day (S44).

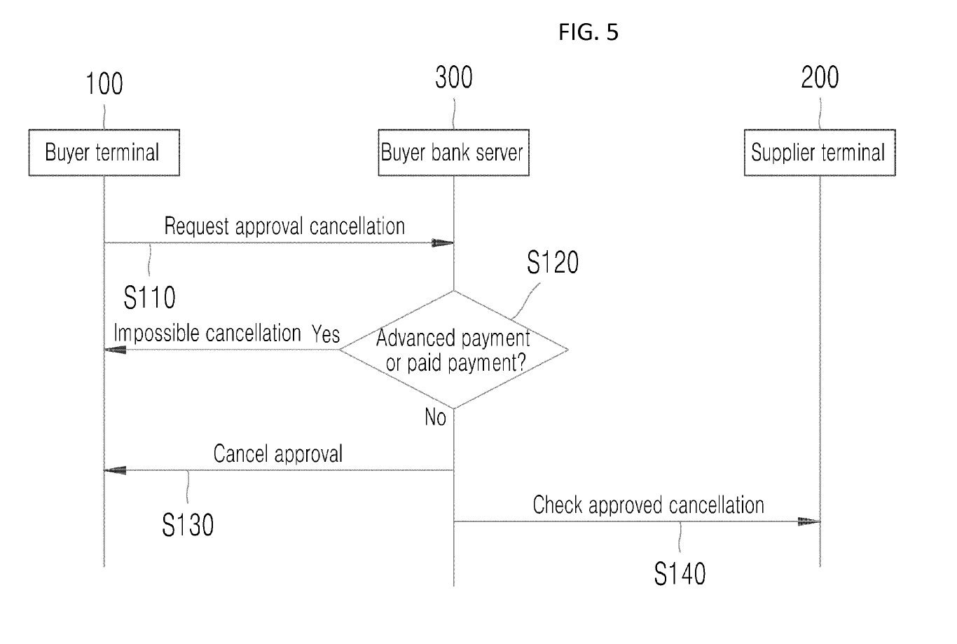

A processing method according to an approval cancellation request is described below with reference to FIG. 5.

When an approval cancellation request is generated from the buyer terminal 100 (S110), the buyer bank server 300 searches the database for an approval history and determines whether advanced payment or paid payment has been performed (S120).

Here, if the advanced payment or the paid payment does not exist in the determination step (S120) (NO), the buyer bank server 300 processes approval cancellation (S130).

Next, the buyer bank server 300 informs the buyer terminal 100 of the approval cancellation and also enables the supplier terminal 200 to search for an approval cancellation history (S140).

In contrast, if the advanced payment or the paid payment exists in the determination step (S110) (YES), the buyer bank server 300 informs the buyer terminal 100 that approval cancellation is impossible (S140).

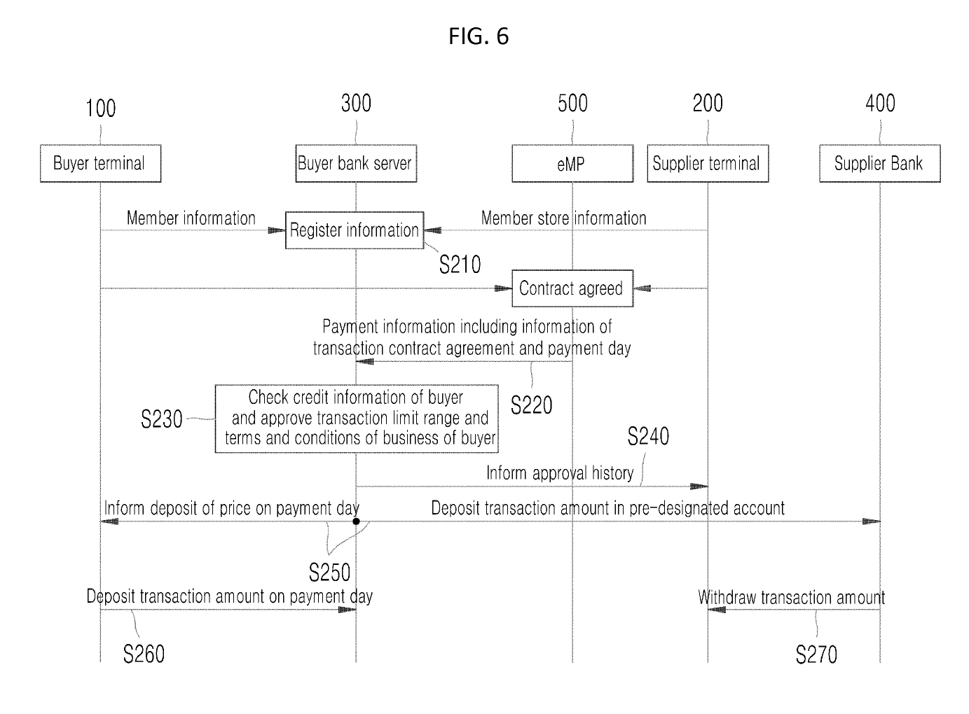

An international trade payment method based on a buyer bank using a credit card system between a buyer and a supplier according to a second embodiment of the present invention is described with reference to FIG. 6.

First, the buyer bank server 300 receives card member information about a buyer, including information about the terms and conditions of business and payment account of the buyer, from the buyer terminal 100 and information about the member store of a supplier and stores and registers the card member information about a buyer and the information about the member store of a supplier in and with the database (S210).

Next, after the buyer and the supplier agrees a contract in the eMP 500, the buyer bank server 300 receives information about a transaction contract agreement and payment information, including a payment day set by the buyer, through the eMP 500 (S220).

When the information about the transaction contract agreement is received (an approval request), the buyer bank server 300 processes approval according to the transaction limit range and the terms and conditions of business of the buyer by searching for credit information about the buyer which is registered with the database (S230).

Next, the buyer bank server 300 informs the supplier terminal 200 of the approval history of the buyer (S240).

Next, the buyer bank server 300 informs that the buyer terminal 100 must deposit the price on the payment day and performs processing so that the transaction amount is deposited in the pre-designated account of the supplier, designated when member store information was registered, on the payment day (S250).

Furthermore, when the buyer terminal 100 deposits the transaction amount on the payment day, the buyer bank server 300 completes the transaction amount redemption processing of the buyer (S260).

Meanwhile, the supplier 200 settles an expiration amount by withdrawing the transaction amount from the pre-designated account of the supplier bank 400, designated when member store was registered, on the payment day (S270).

In contrast, in the step (S3) of searches for registered credit information about the buyer when the information about the transaction contract agreement is received (an approval request) and approving the transaction limit range and terms and conditions of business of the buyer, an example in which the buyer bank server 300 gives approval on condition that buyer confirmation is essential in the terms and conditions of business approved between the buyer and the supplier is described with reference to FIG. 4.

First, the buyer bank server 300 receives a buyer confirmation request history from the buyer terminal 100 and processes buyer confirmation (S31).

Next, the buyer bank server 300 informs the buyer terminal 100 of the result of the buyer confirmation processing (S32).

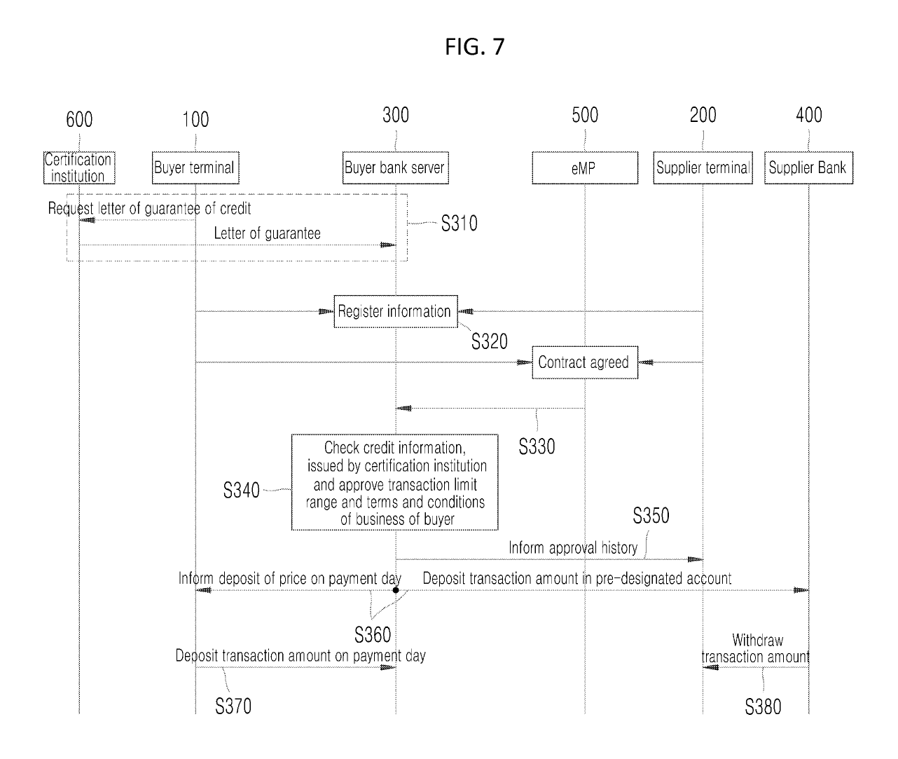

An international trade payment method based on the buyer bank server 300 using a credit card system between the buyer terminal 100 and the supplier terminal 200 according to a third embodiment of the present invention is described below with reference to FIG. 7.

First, the buyer bank server 300 receives the credit letter of guarantee of a buyer, issued by a certification institution 600, from the buyer terminal 100 or the certification institution 600 (S310).

Furthermore, the buyer bank server 300 receives card member information about a buyer, including information about terms and conditions of business and payment account of the buyer, and information about the member store of a supplier, including information about the pre-designated account of the supplier, from the buyer terminal 100 and registers the card member information about the buyer and the information about the member store of the supplier with the database (S320).

Next, the buyer bank server 300 receives information about a transaction contract agreement and payment information, including a payment day set by the buyer, from the eMP 500 through the eMP 500 after the buyer and the supplier made the contract (S330).

When information about the transaction contract agreement is received (an approval request), the buyer bank server 300 searches the database for the credit information about the buyer issued by the certification institution 600 and processes approval according to the transaction limit range and terms and conditions of business of the buyer (S340).

Next, the buyer bank server 300 informs the supplier terminal 200 of the approval history of the buyer by sending the approval history to the supplier terminal 200 (S350).

Meanwhile, the buyer bank server 300 informs that the buyer terminal 100 must deposit a price on the payment day and performs processing so that the transaction amount is deposited in the pre-designated account of the supplier, designated when member store information was registered, on the payment day (S360).

Furthermore, when the buyer terminal 100 deposits the transaction amount on the payment day, the buyer bank server 300 completes the transaction amount redemption processing of the buyer (S370).

Meanwhile, the supplier 200 settles an expiration amount by withdrawing the transaction amount from the pre-designated account of the supplier bank 400, designated when member store was registered, on the payment day (S380).

In contrast, in the step (S3) of searches for registered credit information about the buyer when the information about the transaction contract agreement is received (an approval request) and approving the transaction limit range and terms and conditions of business of the buyer, an example in which the buyer bank server 300 gives approval on condition that buyer confirmation is essential in the terms and conditions of business approved between the buyer and the supplier is described with reference to FIG. 4.

First, the buyer bank server 300 receives a buyer confirmation request history from the buyer terminal 100 and processes buyer confirmation (S31).

Next, the buyer bank server 300 informs the buyer terminal 100 of the result of the buyer confirmation processing (S32).

Although the basic and novel characteristics of the present invention have been shown and described as the above-described description has been applied to several embodiments, those skilled in the art will understand that the form and details of the illustrated system may be omitted, replaced, and modified without departing from the scope of the present invention.

The international trade payment system and method based on a buyer bank using a credit card system can provide a more convenient international trade system by enabling the payment of a transaction amount between a buyer and a supplier using only a server in an importing country.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. An international trade payment method based on a buyer bank using a credit card system interconnected over a network, comprising the steps of:
a buyer bank server receiving card member information about a buyer, including information about terms and conditions of business and a payment account of the buyer, and information about a member store of a supplier, including information about a pre-designated account of the supplier, from a buyer terminal and registering the card member information and the information about the member store with a database;
the buyer bank server receiving information about a transaction contract agreement with the supplier and payment information, including a payment day set by the buyer, from the buyer terminal;
the buyer bank server searching the database for registration credit information about the buyer when the information about the transaction contract agreement is received (an approval request) and processing approval according to a transaction limit range and the terms and conditions of business of the buyer;
the buyer bank server informing a supplier terminal of an approval history of the buyer by sending the approval history to the supplier terminal;
the buyer bank server informing the buyer terminal that a price is deposited on the payment day and performing processing so that the transaction amount is deposited in the pre-designated account of the supplier, designated when member store information was registered, on the payment day; and
the buyer bank server completing transaction amount redemption processing of the buyer when the buyer terminal deposits the transaction amount on the payment day.

2. The international trade payment method according to claim 1, further comprising the steps of:
if the approval is processed on condition that buyer confirmation is essential in the approved terms and conditions of business between the buyer and the supplier,
the buyer bank server receiving a buyer confirmation request history from the buyer terminal and processing the buyer confirmation; and
the buyer bank server informing the buyer terminal of a result of the buyer confirmation processing by sending the result of the buyer confirmation processing to the buyer terminal.

3. The international trade payment method according to claim 2, further comprising the step of, if the supplier requests advanced payment prior to the payment day of the transaction amount, the buyer bank server checking the approval history and a buyer confirmation history, subtracting a commission from the transaction amount according to a commission rate calculated based on a credit rating of the buyer, and performing processing so that the remaining amount is deposited in the pre-designated account of the supplier, designated when member store information was registered, prior to the payment day of the transaction amount.

4. The international trade payment method according to claim 1, further comprising the steps of:
when an approval cancellation request is generated from the buyer, the buyer bank server checking the approval history and determining whether it is advanced payment or paid payment;
the buyer bank server cancelling the approval if the advanced payment or the paid payment does not exist in the determination step;
the buyer bank server informing the buyer terminal of the approval cancellation by sending the approval cancellation to the buyer terminal and also enabling the supplier terminal to search for an approval cancellation history; and
the buyer bank server informing the buyer terminal that the approval cancellation is impossible if the advanced payment or the paid payment exists in the determination step.

5. The international trade payment method according to claim 1, wherein the buyer bank server guarantees a price for the supplier, when the transaction between the buyer and the supplier is approved.

6. The international trade payment method according to claim 2, wherein the buyer bank server informs the buyer terminal of the result of the buyer confirmation processing and then guarantees a price for the supplier.

7. An international trade payment method based on a buyer bank using a credit card system interconnected over a network, comprising the steps of:
a buyer bank server receiving card member information about a buyer, including information about terms and conditions of business and a payment account of the buyer, and information about a member store of a supplier, including information about a pre-designated account of the supplier, from a buyer terminal and registering the card member information and the information about the member store with a database;
the buyer bank server receiving information about a transaction contract agreement and payment information, including a payment day set by the buyer, from an eMP through the eMP after the buyer and the supplier made the contract;
the buyer bank server searching the database for registration credit information about the buyer when the information about the transaction contract agreement is received (an approval request) and processing approval according to a transaction limit range and the terms and conditions of business of the buyer;
the buyer bank server informing a supplier terminal of an approval history of the buyer by sending the approval history to the supplier terminal;
the buyer bank server informing the buyer terminal that a price is deposited on the payment day and performing processing so that the transaction amount is deposited in the pre-designated account of the supplier, designated when member store information was registered, on the payment day; and
the buyer bank server completing transaction amount redemption processing of the buyer when the buyer terminal deposits the transaction amount on the payment day.

8. The international trade payment method according to claim 7, further comprising the steps of:
if the approval is processed on condition that buyer confirmation is essential in the approved terms and conditions of business between the buyer and the supplier,
the buyer bank server receiving a buyer confirmation request history from the buyer terminal and processing the buyer confirmation; and
the buyer bank server informing the buyer terminal of a result of the buyer confirmation processing by sending the result of the buyer confirmation processing to the buyer terminal.

9. An international trade payment method based on a buyer bank using a credit card system interconnected over a network, comprising the steps of:
a buyer bank server receiving a credit letter of guarantee of a buyer, issued by a certification institution, from the buyer or the certification institution;
the buyer bank server receiving card member information about the buyer, including information about terms and conditions of business and a payment account of the buyer, and information about a member store of a supplier, including information about a pre-designated account of the supplier, from a buyer terminal and registering the card member information and the information about the member store with a database;
the buyer bank server receiving information about a transaction contract agreement and payment information, including a payment day set by the buyer, from an eMP through the eMP after the buyer and the supplier made the contract;
the buyer bank server searching the database for credit information about the buyer, issued by the certification institution, when information about the transaction contract agreement is received (an approval request) and processing approval according to a transaction limit range and terms and conditions of business of the buyer;
the buyer bank server informing a supplier terminal of an approval history of the buyer by sending the approval history to the supplier terminal;
the buyer bank server informing the buyer terminal that a price is deposited on the payment day and performing processing so that the transaction amount is deposited in the pre-designated account of the supplier, designated when member store information was registered, on the payment day; and
the buyer bank server completing transaction amount redemption processing of the buyer when the buyer terminal deposits the transaction amount on the payment day.

10. The international trade payment method according to claim 9, further comprising the steps of:
if the approval is processed on condition that buyer confirmation is essential in the approved terms and conditions of business between the buyer and the supplier,
the buyer bank server receiving a buyer confirmation request history from the buyer terminal and processing the buyer confirmation; and
the buyer bank server informing the buyer terminal of a result of the buyer confirmation processing by sending the result of the buyer confirmation processing to the buyer terminal.

11. An international trade payment system based on a buyer bank using a credit card system interconnected over a network, comprising:
a database for storing card member information about a buyer, including information about terms and conditions of business and a payment account, information about a member store of a supplier, credit information about the buyer, including a transaction limit range and terms and conditions of business of the buyer, and information about a pre-designated account of the supplier;
a card member management unit/member store management unit for storing and registering the card member information about the buyer, including the information about the terms and conditions of business and the payment account of the buyer, and the information about the member store of the supplier, including the information about the pre-designated account of the supplier, in and with the database;
an approval processing unit for searching for credit information about the buyer registered with the database when information about a transaction contract agreement with the supplier and payment information including a payment day set by the buyer is received from a buyer terminal, giving approval according to the transaction limit range and the terms and conditions of business of the buyer, and informing a supplier terminal of an approval history of the buyer; and
a card payment processing unit for informing that the buyer deposits a price on the payment day, performing processing so that the transaction amount is deposited in the pre-designated account of the supplier, designated when member store information was registered, on the payment day, and completing transaction amount redemption processing of the buyer when the buyer deposits the transaction amount on the payment day.

12. The international trade payment system according to claim 11, further comprising a buyer confirmation processing unit for, if the approval is processed on condition that buyer confirmation is essential in the approved terms and conditions of business between the buyer and the supplier, receiving a buyer confirmation request history from the buyer, processing the buyer confirmation, and informing the buyer of a result of the buyer confirmation processing.

13. The international trade payment system according to claim 12, further comprising an advanced payment processing unit for, if the supplier requests advanced payment prior to the payment day of the transaction amount, checking the approval history and a buyer confirmation history, subtracting a commission from the transaction amount according to a commission rate calculated based on a credit rating of the buyer, and depositing the remaining amount in the pre-designated account of the supplier, designated when member store information was registered, prior to the payment day of the transaction amount.

14. The international trade payment system according to claim 11, wherein the buyer bank server further comprises an eMP management unit for receiving information about a transaction contract agreement and payment information, including a payment day set by the buyer, from an eMP through the eMP after the buyer and the supplier made the contract;

15. The international trade payment system according to claim 11, wherein the buyer bank server further comprises a letter-of-guarantee management unit for receiving a credit letter of guarantee of the buyer, issued by a certification institution, from the buyer or the certification institution, receiving the card member information about the buyer, including the information about the terms and conditions of business and the payment account of the buyer, and the member store information, and registering the card member information and the member store information with the database.

16. The international trade payment system according to claim 11, wherein the buyer bank server guarantees the price for the supplier when a transaction between the buyer and the supplier is approved.

17. The international trade payment system according to claim 12, wherein the buyer bank server informs the buyer of a result of the buyer confirmation processing, and the buyer bank server guarantees for the price for the supplier.
